(19) United States
(12) Patent Application Publication
(10) Pub. No.: US 2013/0068109 A1
(43) Pub. Date: Mar. 21, 2013

(54) SINGLE SERVE BEVERAGE CAPSULE INCLUDING A MIXING CHAMBER WITH BEVERAGE MEDIA

(71) Applicants: Christopher C. Pribus, Laguna Beach, CA (US); John J. Fong, Irvine, CA (US); Brett D. Freeman, Aliso Viejo, CA (US)

(72) Inventors: Christopher C. Pribus, Laguna Beach, CA (US); John J. Fong, Irvine, CA (US); Brett D. Freeman, Aliso Viejo, CA (US)

(21) Appl. No.: 13/442,738

(22) Filed: Apr. 9, 2012

Related U.S. Application Data
(60) Provisional application No. 61/537,218, filed on Sep. 21, 2011.

(51) Int. Cl. B65D 85/808; A47J 31/46; A47J 31/00

(52) U.S. Cl. 99/295; 426/112; 426/77

(57) ABSTRACT

There is provided a single serve beverage capsule. The capsule includes a capsule housing, an inlet, a mixing chamber disposed in the capsule housing in fluid communication with the inlet, an outlet reservoir disposed in the capsule housing in fluid communication with the mixing chamber, an outlet disposed in the fluid communication with the outlet reservoir, and beverage media disposed within the mixing chamber. The beverage media is substantially dissolvable in an aqueous based liquid. The inlet, the mixing chamber, outlet reservoir, and the outlet sequentially defines an unfiltered fluid path with respect to the dissolvable beverage media after having been immersed in an ambient temperature fluid. In another embodiment the mixing chamber is sized and configured to create wave-like mixing of a single serve amount of liquid. A beverage dispensing system is also provided that includes the capsule and a beverage dispenser.

### CROSS-REFERENCE TO RELATED APPLICATIONS

The present non-provisional patent application claims priority to U.S. Provisional Patent Application Ser. No. 61/537,218 filed on Sep. 21, 2011 entitled “Single Serve Functional Beverage Machine” and U.S. Provisional Patent Application Ser. No. 61/538,328 filed on Sep. 23, 2011 entitled “Single Serve Functional Beverage Machine,” the contents of both applications being incorporated herein by reference. The present non-provisional patent application is also related to a non-provisional patent application Ser. No. ______ filed concurrently herewith entitled “SINGLE SERVE BEVERAGE DISPENSING SYSTEM INCLUDING AN IONIZER.”

### STATEMENT RE: FEDERALLY SPONSORED RESEARCH/DEVELOPMENT

Not Applicable

### BACKGROUND

1. Technical Field

The present disclosure generally relates to beverage dispensing devices, and more particularly, to a single serve beverage capsule including a mixing chamber with beverage media.

2. Related Art

A water ionizer separates water into alkaline and acid fractions using a process known as electrolysis. It does this by exploiting the electric charge of the calcium and magnesium ions present in nearly all sources of tap drinking water. Alkaline is defined as having a pH value greater than 7.0. The pH value is a measure of the acidity or alkalinity of a solution. The pH scale runs from 0 to 14, with 7.0 considered neutral. pH values below 7.0 are considered acidic, and pH values above 7.0 are considered alkaline. Alkaline water may be utilized to improve the hydration of a person's body. In this regard approximately 70% of a person's body is made up of water, and water is the medium through which cellular functions occur. Alkaline water is characterized as having reduced surface tension and reduced number of molecules in comparison to “ordinary” or tap water. As such, alkaline water may be used as an aid in transportation and absorption of vitamins, minerals, and other essential nutrients to various organs more rapidly than in compassion to ordinary water. Likewise, alkaline water is believed to detoxification of the body's cells as well.

There are a variety of consumer water ionizers available in the marketplace that are intended for home use. These devices are typically counter-mounted or under-counter mounted arrangements. A tap water line may be attached to the device or the device may have a water reservoir which the user periodically fills. In any event these devices are configured to allow alkaline water to be readily available “on tap.”

Bottled alkaline water is also available in the marketplace. However, these bottle beverages may not be as beneficial depending upon the product shelf life in comparison to ready made alkaline water. Further, bottled beverages produce packaging waste.

In addition, there are a number of single-shot or single serve hot beverage dispensers available for home use. These dispensers utilize a single serve capsule that typically includes a filter and beverage medium, such as ground coffee or tea leaves. The dispenser injects a single serve amount of hot water into and through the single shot capsule. A hot water nozzle is pieced through a top of the capsule and an outlet nozzle is pierced through the bottom of the capsule. Hot water is injected from the hot water nozzle. The resulting liquid beverage is then dispensed through the outlet nozzle into a user's cup. In this regard, the hot water is used to extract elements of the beverage medium to form the resulting liquid beverage with a remainder of the beverage medium (e.g., coffee grinds or tea leaves) remaining in the used capsule for disposal.

So-called functional beverages are beverage products that are non-alcoholic, ready to drink and include in their formulation non-traditional ingredients. This may includes herbs, vitamins, minerals, amino acids or additional raw fruit or vegetable ingredients, so as to provide specific health benefits that go beyond general nutrition. Sports and performance drinks, energy drinks, ready to drink (RTD) teas, enhanced fruit drinks, soy beverages and alkaline water, among others, are some of the product marketed as functional beverages. Functional beverages are widely available in premixed bottles and cans. However, such bottle/can product packaging is considered wasteful or waste producing and therefore undesirable from this perspective alone. Moreover, the inherent nature of bringing functional beverages to market in bottles and cans is relatively expensive. Functional beverages are also available in beverage power form in packet packaging that required manual mixture with water. Insufficient manual mixture may result in undissolved portions of the beverage power being present at the bottom of a beverage cup.

It is contemplated that the above described prior art beverages and beverage dispensing systems are limited in terms of variety of beverage selection, cost and packaging constraints and means of dispensing. Accordingly, there is a need in the art for an improved beverage dispensing system.

### BRIEF SUMMARY

According to an aspect of the invention, there is provided a single serve beverage capsule. The capsule includes a capsule housing, an inlet, a mixing chamber disposed in the capsule housing in fluid communication with the inlet, an outlet reservoir disposed in the capsule housing in fluid communication with the mixing chamber, an outlet disposed in the fluid communication with the outlet reservoir, and beverage media disposed within the mixing chamber. The beverage media is substantially dissolvable in an aqueous based liquid. The inlet, the mixing chamber, outlet reservoir, and the outlet sequentially defines an unfiltered fluid path with respect to the dissolvable beverage media after having been immersed in an ambient temperature fluid.

According to various embodiments, the inlet may be centered within the mixing chamber, and the inlet may be disposed opposite the outlet. The capsule may further include a membrane disposed across the inlet. The mixing chamber may include a generally half-toroidal shaped portion. The mixing chamber may be generally toroidal shaped. The outlet may include a one-way valve sized and configured to allow fluidic flow from the outlet reservoir to beyond the capsule housing. The one-way valve may be a mushroom valve. The outlet reservoir may be disposed circumferentially about the mixing chamber. The capsule may further include a plurality of openings disposed between the mixing chamber and the outlet reservoir, the unfiltered fluid path extends through the plurality of openings. The plurality of openings may be disposed circumferentially about the mixing chamber. The capsule may further include a mixing chamber insert. The mixing chamber is defined by and disposed within the mixing chamber insert, and the outlet reservoir is disposed between the mixing chamber insert and the capsule housing. The capsule may further include a plurality of openings formed in the mixing chamber insert, and the unfiltered fluid path extends through the plurality of openings. The plurality of openings is disposed circumferentially about the mixing chamber. The beverage media may be substantially dissolvable in an aqueous based liquid at ambient temperature.

According to another embodiment, there is provided a single serve beverage capsule for use with a single serve amount of liquid. The capsule includes a capsule housing, an inlet, a mixing chamber disposed in the capsule housing in fluid communication with the inlet, an outlet reservoir disposed in the capsule housing in fluid communication with the mixing chamber, an outlet disposed in the fluid communication with the outlet reservoir, beverage media disposed within the mixing chamber. The mixing chamber is sized and configured to create wave-like mixing of a single serve amount of liquid from the inlet.

The beverage media may be substantially dissolvable in a single serve amount of liquid flowing through the mixing chamber. The mixing chamber may include a generally half-toroidal shaped portion. The beverage media may be substantially dissolvable in an aqueous based liquid. The beverage media may be substantially dissolvable in an aqueous based liquid at ambient temperature. The inlet, the mixing chamber, outlet reservoir, and the outlet may sequentially define an unfiltered fluid path with respect to the beverage media after having been immersed in an ambient temperature fluid.

According to another embodiment, there is provided a single service beverage system that includes a single serve beverage capsule and beverage dispenser. The single serve beverage capsule includes a capsule housing, an inlet, a mixing chamber disposed in the capsule housing in fluid communication with the inlet, an outlet reservoir disposed in the capsule housing in fluid communication with the mixing chamber, an outlet disposed in the fluid communication with the outlet reservoir, and beverage media disposed within the mixing chamber, the beverage media being substantially dissolvable in an aqueous based liquid. The inlet, the mixing chamber, outlet reservoir, and the outlet sequentially defines an unfiltered fluid path with respect to the dissolvable beverage media after having been immersed in an ambient temperature fluid. The beverage dispenser includes a water reservoir sized and configured to retain reservoir water, a mixing fixture sized and configured to receive the single serve beverage capsule, an inlet piercing element in fluid communication with the single serve beverage capsule, and a pump in fluid communication with the inlet piercing element and the water reservoir. The pump is sized and configured to pump reservoir water from the water reservoir to the inlet piercing element through the capsule and out the outlet. The beverage dispenser may further include a valve in fluid communication with the pump and the inlet piercing element. The valve is sized and configured to release a single serve amount of reservoir water from the pump and through the single service beverage capsule.

According to yet another embodiment, there is provided a single service beverage system that includes a single serve beverage capsule and a beverage dispenser. The single serve beverage capsule includes a capsule housing, an inlet, a mixing chamber disposed in the capsule housing in fluid communication with the inlet, an outlet reservoir disposed in the capsule housing in fluid communication with the mixing chamber, an outlet disposed in the fluid communication with the outlet reservoir, and beverage media disposed within the mixing chamber. The mixing chamber is sized and configured to create wave-like mixing of a single serve amount of liquid from the inlet. The beverage dispenser includes a water reservoir sized and configured to retain reservoir water, a mixing fixture sized and configured to receive the single serve beverage capsule, an inlet piercing element in fluid communication with the single serve beverage capsule, and a pump in fluid communication with the inlet piercing element and the water reservoir. The pump is sized and configured to pump reservoir water from the water reservoir to the inlet piercing element through the capsule and out the outlet. The beverage dispenser may further include a valve in fluid communication with the pump and the inlet piercing element, the valve being sized and configured to release a single serve amount of reservoir water from the pump and through the single service beverage capsule.

The presently contemplated embodiments will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 depicts a perspective view of a single serve beverage dispenser according to an aspect of the invention;

FIG. 2 depicts a symbolic diagram of a single serve beverage system including a single serve beverage dispenser and a capsule;

FIG. 3 depicts an exploded cross sectional side view of a single serve beverage capsule;

FIG. 4 depicts an assembled cross sectional side view of the single serve beverage capsule of FIG. 3;

FIG. 5 depicts an exploded perspective side view of the single serve beverage capsule of FIG. 3;

FIG. 6 depicts an assembled perspective side view of the single serve beverage capsule of FIG. 4;

FIG. 7 depicts a top perspective view of a mixing chamber insert and a capsule housing of the single serve beverage capsule of FIG. 3; and

FIGS. 8-11 sequentially depict the assembled cross sectional side view of the single serve beverage capsule of FIG. 4 as interacting with a fluid nozzle of a single serve beverage dispenser; and

FIG. 12 depicts a symbolic diagram of a single serve beverage system, according to another embodiment, including a single serve beverage dispenser and a capsule.

Common reference numerals are used throughout the drawings and the detailed description to indicate the same elements.

### DETAILED DESCRIPTION

The detailed description set forth below in connection with the appended drawings is intended as a description of the presently preferred embodiments of the invention, and is not intended to represent the only form in which the present devices may be developed or utilized. It is to be understood, however, that the same or equivalent functions may be accomplished by different embodiments that are also intended to be encompassed within the spirit and scope of the invention. It is further understood that the use of relational terms such as first, second, and the like are used solely to distinguish one from another entity without necessarily requiring or implying any actual such relationship or order between such entities.

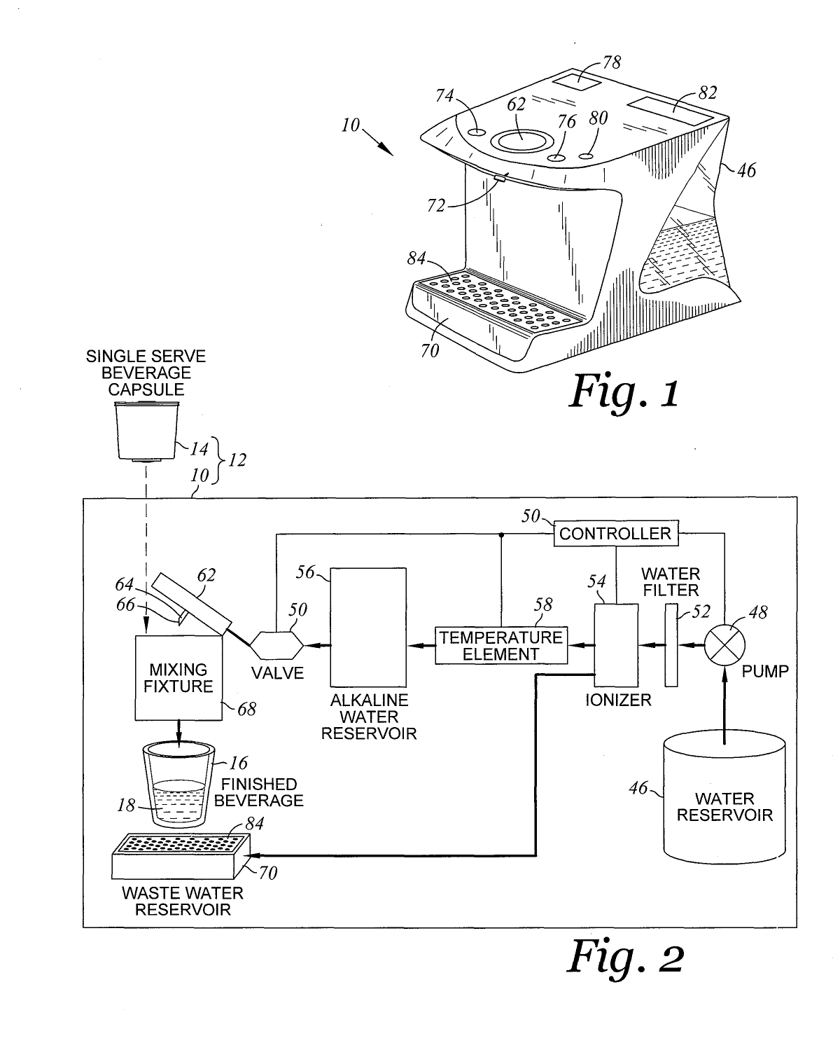

Referring now FIG. 1 there is depicted a perspective view of a single serve beverage dispenser 10 according to an aspect of the invention. FIG. 2 depicts a symbolic diagram of a single serve beverage system 12 that includes the single serve beverage dispenser 10 and a single serve beverage capsule 14 according to another aspect of the present invention. The single serve beverage capsule 14 is suitable for use with the single serve beverage dispenser 10. The single serve beverage dispense 10 of FIG. 2 is depicted with a beverage cup 16 and that includes a finished beverage 18.

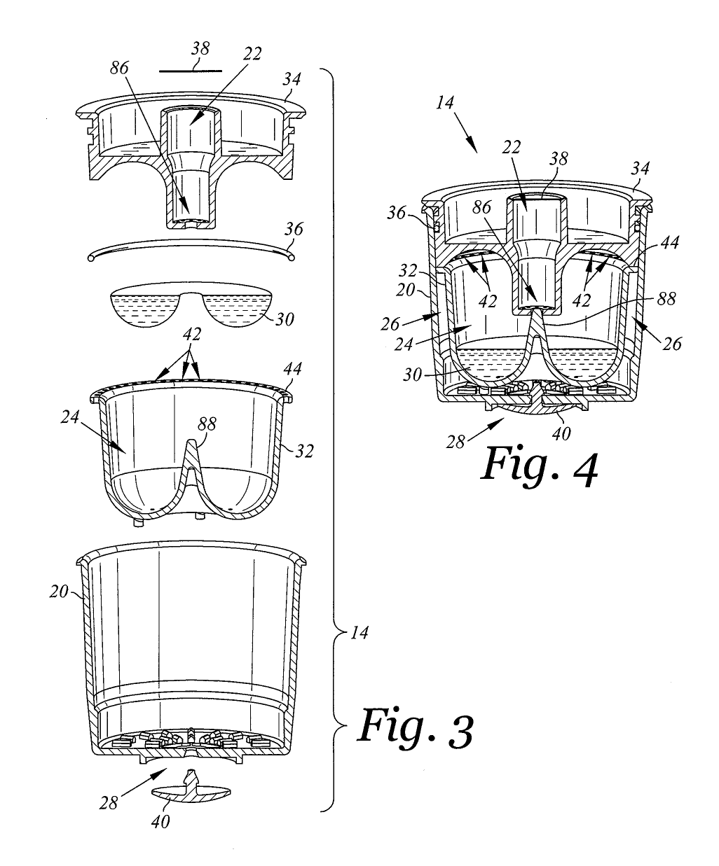

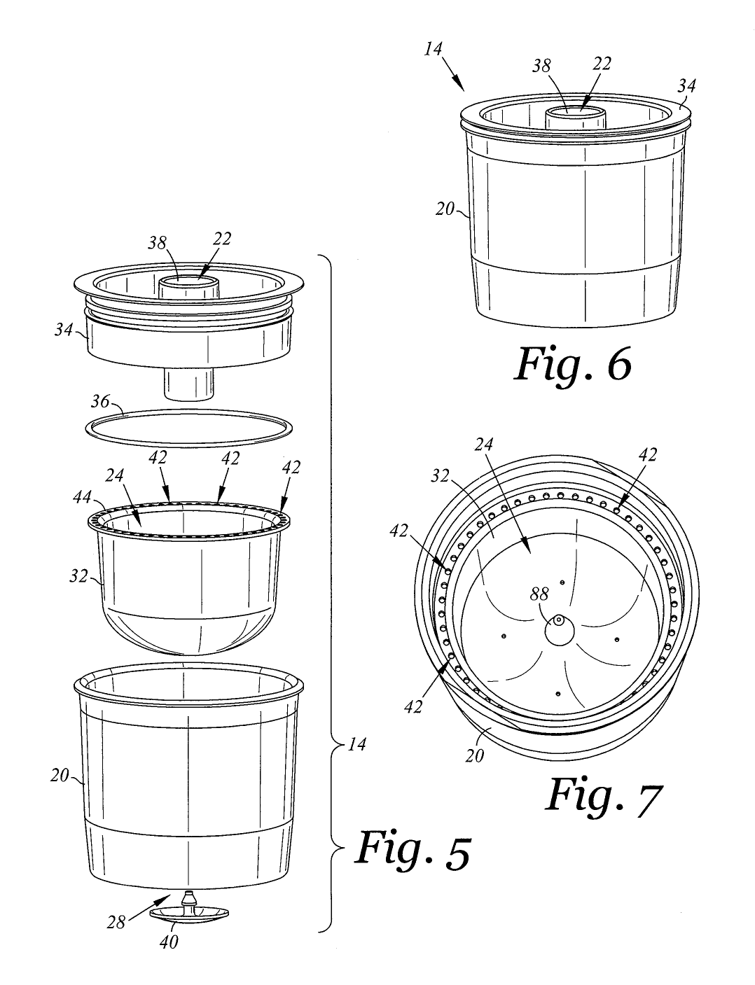

Referring additionally to FIG. 3 there is depicted an exploded cross sectional side view of the single serve beverage capsule 14. FIG. 4 depicts an assembled cross sectional side view of the single serve beverage capsule 14 of FIG. 3. FIG. 5 depicts an exploded perspective side view of the single serve beverage capsule 14 of FIG. 3, and FIG. 6 depicts an assembled perspective side view of the single serve beverage capsule 14 of FIG. 4.

As will be discussed in further detail below, according to an aspect of the invention, the single serve beverage capsule 14 includes a capsule housing 20, an inlet 22, a mixing chamber 24 disposed in the capsule housing 20 in fluid communication with the inlet 22, an outlet reservoir 26 (as indicated in FIG. 4) disposed in the capsule housing 20 in fluid communication with the mixing chamber 24, an outlet 28 disposed in the fluid communication with the outlet reservoir 26, and beverage media 30 disposed within the outlet reservoir 26. The beverage media 30 is substantially dissolvable in an aqueous based liquid. The inlet 22, the mixing chamber 24, outlet reservoir 26, and the outlet 28 sequentially define an unfiltered fluid path with respect to the dissolvable beverage media 30 after having been immersed in an ambient temperature fluid.

In further detail, according to various embodiments, the single serve beverage capsule 14 may includes a mixing chamber insert 32. Referring additionally to FIG. 7, there is depicted a top perspective view of a mixing chamber insert 32 and the capsule housing 20 of the single serve beverage capsule 14 of FIG. 3. The mixing chamber 24 is defined by and disposed within the mixing chamber insert 32. The mixing chamber insert 32 is sized and configured to be inserted within the capsule housing 20. The mixing chamber insert 32 may be press fit within the capsule housing 20. The outlet reservoir 26 is disposed between the mixing chamber insert 32 and the capsule housing 20. The outlet reservoir 26 may be disposed circumferentially about the mixing chamber 24, and in particular the mixing chamber insert 32.

The capsule 14 may further include an inlet insert 34. The inlet insert 34 is sized and configured to be inserted within the capsule housing 20. The inlet insert 34 may be press fit within the capsule housing 20. An o-ring 36 may be disposed circumferentially about the inlet insert 34 to facilitate a seal between the inlet insert 34 and the capsule housing 20. The inlet 22 is formed within and through the inlet insert 34. An inlet seal 38 may be provided. The inlet seal 38 is disposed across the inlet 22. At an opposing end of the capsule housing 20, the outlet 28 may include and be sealed with a one-way valve 40. The one-way valve 40 is sized and configured to allow fluidic flow from the outlet reservoir 26 to beyond the capsule housing 20. The one-way valve 40 may be a mushroom valve for example. With this general configuration, the beverage media 30 may be contained in the capsule 14 in an airtight environment. This is contemplated to facilitate freshness of the beverage media 30. It is contemplated that the outlet 28 may be formed during the beverage dispensing process by being punctured into the capsule housing 20 (rather than pre-formed as provided in the embodiment depicted).

In the embodiment depicted, the mixing chamber insert 32 and the inlet insert 34 cooperatively form the mixing chamber 24 with the mixing chamber insert 32 forming a lower portion and the inlet insert 34 forming an upper portion. With the beverage capsule 14 in an upright position, such as depicted, the beverage media 30 resides within the mixing chamber insert 32. The mixing chamber 24 is characterized by a curved surface. In this regard, the mixing chamber 24 may include a generally half-toroidal shaped portion. In this embodiment, the mixing chamber insert 32 defines a generally half-toroidal shaped portion of the mixing chamber 24. Similarly, the inlet insert 34 defines a generally half-toroidal shaped portion of the mixing chamber 24. As such, with opposing portions of the mixing chamber 24 both being generally half-toroidal shaped portions, the mixing chamber 24 is generally toroidal shaped. As used herein, the term generally half-toroid shaped refers to a surface that may be characterized as being defined through the rotation of an arced segment about a common central axis. The resulting toroidal shape is contemplated to be particularly effective in producing wave-like and/or turbulent mixing of fluid injected into the mixing chamber 24 as further discussed below.

In the embodiment depicted, the inlet 22 is centered within the mixing chamber 24, and the inlet 22 is disposed opposite the outlet 28. However, it is contemplated that other configurations may be implemented. In this regard, the inlet 22 may be off-centered or bias towards a portion of the capsule housing 20. Further, in other embodiments, the inlet 22 and/or outlet 28 may be disposed at a side wall of the capsule housing 20 for example. The inlet insert 23 may include exit openings 86 that further define the inlet 22. The exit openings 86 open to the mixing chamber 32. The mixing chamber insert 32 may include a vertex 88 that further defines the mixing chamber 24.

According to another embodiment, there is provided the single serve beverage capsule 14 for use with a single serve amount of liquid. The capsule 14 includes the capsule housing 20, the inlet 22, the mixing chamber 24 disposed in the capsule housing 20 in fluid communication with the inlet 22, the outlet reservoir 26 disposed in the capsule housing 20 in fluid communication with the mixing chamber 24, the outlet 28 disposed in the fluid communication with the outlet reservoir 26, and the beverage media 30 disposed within the mixing chamber 24. The mixing chamber 24 is sized and configured to create wave-like or turbulent mixing of a single serve amount of liquid from the inlet 22. As used herein the term turbulent mixing refers to the nature of the fluid flow path through the capsule 14 being substantially swirling and/or turbulent as opposed to having laminar flow characteristics. The nature of the wave-like or turbulent mixing may also be characterized as being tornado-like. The wave-like mixing is particularly advantageous when used in connection with beverage media 30 at or below ambient temperature. It is contemplated that the prior art dispensing systems have avoided ambient temperature or below mixing of beverage media because of the difficulties of beverage media to effectively mix (in comparison to hot mixing/dispensing). However, such prior art difficulties are overcome by the wave-like mixing induced by the particular configuration of the mixing chamber 24.

According to additional embodiments, the capsule 14 may further include a plurality of openings 42 disposed between the mixing chamber 24 and the outlet reservoir 26. The plurality of openings 42 may be disposed circumferentially about the mixing chamber 24. The plurality of openings 42 are formed in and through the mixing chamber insert 32. The unfiltered fluid path extends through the plurality of openings 42. In the embodiment depicted, the plurality of openings 42 are form through an outer lip 44 of the mixing chamber insert 32 at one end of the mixing chamber insert 32 adjacent the inlet insert 34. It is contemplated that the plurality of openings need not be disposed at such location. Moreover, the unfiltered fluid path may extend through other openings or passageways. While the plurality of openings 42 are formed as holes in this embodiment, the plurality of openings may take the form of notches or spacings formed in the outer lip 44 or holes through a side wall of the mixing chamber insert 32 or the inlet insert 34. It is understood that a function of the plurality of openings 42 is to allow fluid from the mixing chamber 24 to pass to the outlet reservoir 26. However, the plurality of openings 42 is contemplated to be strategically located so as to facilitate fluid in the mixing chamber 24 to turbulently mix with the beverage media 30 prior exiting the mixing chamber 24.

As mentioned above the beverage media 30 is substantially dissolvable in an aqueous based liquid. As used herein substantially dissolvable refers to at least a majority of the beverage media 30 passing into an aqueous based liquid, such as water, when mixed. Preferably, the beverage media 30 is substantially dissolvable in an aqueous based liquid at ambient temperature. It is contemplated that the beverage media 30 may be formulated so as to have a higher or lower relative ability to be dissolved depending upon the particular fluid mixing conditions, such as the specific type of liquid, temperature of the liquid, amount of time of mixing in the mixing chamber 24, and flow rate through the beverage capsule 14. This regard, the beverage media 30 is contemplated to be formed of various particulate matter and ingredients. The degree sizing of the particles forming the beverage media 30 and the particular ingredients would define the degree to which the beverage media 30 would be able to dissolve. In general, but depending upon the particular ingredients of the beverage media 30, it is contemplated that a relative increase of fluid temperature tends to increase the ease of the beverage media 30 to be dissolved in a fluid.

The particular composition of the beverage media 30 may be chosen from any of those which are well know to one of ordinary skill in the art. The beverage media 30 may take the form of a power, solid, liquid, or even semi-solid, like a paste. Such ingredient may include, for examples, fruit powders (such as whole fruit powders, juice powders and extracts), vegetable powders (such as whole vegetable powders, juice powders and extracts), herbal powders (such as whole herbal powders (including teas), juice powders and extracts), sweeteners (such as various sugars (e.g., cane, coconut, maple, etc.), and low caloric sweeteners (e.g. sucralose, stevia, monk fruit, extract, xylitol, etc.), flavors (including natural flavors and organic flavors), gums (to the extent needed, such as guar gum, and locust gum), fibers (such as flax seed fiber, psyillium, husk, and prebiotics), isolated nutrients (including laboratory synthesized nutrients such as vitamins and minerals), so-called superfood powders (such as wheatgrass, spirulina, chlorella), so-called probiotic powders, isolated powders from oils/seeds/nuts (including sterol/stanol powders, mixed tocotrienols and tocopherols), and sea vegetables (such as whole vegetable powders and extracts). Further the beverage media 30 may include various vitamins, minerals, amino acids, antioxidants, and other beneficial supplements.

As mentioned above the inlet 22, the mixing chamber 24, outlet reservoir 26, and the outlet 28 sequentially defines an unfiltered fluid path with respect to the dissolvable beverage media 30. As used herein the term unfiltered fluid path refers to at least a majority of the beverage media 30 being able to exit the beverage capsule 14 after having been mixed with a fluid flowing through the beverage capsule 14. In an embodiment substantially all of the beverage media 30 exits the beverage capsule 14 after having been mixed with a single serve amount fluid flowing through the beverage capsule 14. In this context substantially all refers to all of the beverage media 30 except residue adhered to interior walls of the beverage capsule 14.

According to another embodiment, there is provided the single service beverage system 12 that includes the single serve beverage capsule 14 and beverage dispenser 10. The single serve beverage capsule 14 includes the capsule housing 20, the inlet 22, the mixing chamber 24 disposed in the capsule housing 20 in fluid communication with the inlet 22, the outlet reservoir 26 disposed in the capsule housing 20 in fluid communication with the mixing chamber 24, the outlet 28 disposed in the fluid communication with the outlet reservoir 26, and the beverage media 30 disposed within the mixing chamber 24. The beverage media 30 is substantially dissolvable in an aqueous based liquid. The inlet 22, the mixing chamber 24, outlet reservoir 26, and the outlet 28 sequentially define the unfiltered fluid path with respect to the dissolvable beverage media 30 after having been immersed in an ambient temperature fluid. The beverage dispenser 10 includes a water reservoir 46 sized and configured to retain reservoir water, a mixing fixture 68 sized and configured to receive the single serve beverage capsule 14, an inlet piercing element 66 in fluid communication with the single serve beverage capsule 14, and a pump 48 in fluid communication with the inlet piercing element 66 and the water reservoir 46. The pump 48 is sized and configured to pump reservoir water from the water reservoir 46 to the inlet piercing element 66 through the capsule 14 and out the outlet 28.

According to yet another embodiment, there is provided the single service beverage system 12 that includes the single serve beverage capsule 14 and a beverage dispenser 10. In this embodiment the mixing chamber 24 is required to be sized and configured to create turbulent mixing of a single serve amount of liquid from the inlet 22.

In further detail, the water reservoir 46 is configured to contain reservoir water or other fluids to be used as a starting media for the finished beverage 18. The water reservoir 46 may be configured to slide out so as to facilitate a filling of the water reservoir 46 such as a counter sink facet or other tap source. The water reservoir 48 is fluid communication with a pump 48. The dispenser 10 may include a water filter 52, an ionizer 54, an alkaline water reservoir 56, a temperature element 58, a valve 60, and a cap 62 that includes a fluid nozzle 64 having the inlet piercing element 66. The pump 48 is configured to pump reservoir water through the water filter 52 and to the ionizer 54. The cap 62 and the mixing fixture 68 are cooperatively sized and configured to receive the capsule 14. Closure of the cap 62 facilitates the inlet piercing element 66 to pierce the inlet seal 38. This results in the fluid nozzle 64 being in fluid communication with the inlet 22 of the capsule 14.

According to another embodiment, there is provided the single serve beverage dispensing system 12 that includes the single serve beverage capsule 14 and the dispenser 10. The capsule 14 includes the capsule housing 20, the inlet 22, the mixing chamber 24 disposed in the capsule housing 20 in fluid communication with the inlet 22, the beverage media 30 disposed within the mixing chamber 24, and the outlet 28 disposed in the fluid communication with the mixing chamber 24. The dispenser 10 includes the water reservoir 46, the pump 48, the alkaline water reservoir 56, the mixing fixture 68, and the valve 60. The water reservoir 46 is sized and configured to retain reservoir water. The ionizer 54 is sized and configured produce alkaline water and acidic water from the reservoir water from the water reservoir. The pump 48 is in fluid communication with the water reservoir 46 and the ionizer 54 for pumping reservoir water from the water reservoir 46 to the ionizer 54. The alkaline water reservoir 56 is in fluid communication with the ionizer 54 sized and configured to retain alkaline water from the ionizer 54. The mixing fixture 68 is sized and configured to receive the single serve beverage capsule 14. The valve 60 is in fluid communication with the alkaline water reservoir 56 and the mixing fixture 68. The valve 60 is sized and configured to release a single serve amount of alkaline water from the alkaline water reservoir 56 to the mixing fixture 68 and through the single service beverage capsule 14. According to another embodiment, there is provided the single serve beverage dispenser 10 for use with a single serve beverage capsule 14. The dispenser 10 may be as described above.

As mentioned above, the dispenser 10 includes the ionizer 54. The ionizer 54 may be constructed in accordance with any of those methods and selected from any of those known to one of ordinary skill in the art. Examples of suitable ionizer devices for the ionizer 54 include an electrolysis chamber model no. SR-10-2A, manufactured by Sunrise Environmental Technology Co., Ltd.

The dispenser 10 may further include a waste water reservoir 40. The waste water reservoir 70 is in fluid communication with the ionizer 54 for receiving acidic water there from. In addition, the dispenser may include a horizontal beverage cup support 84 for supporting a beverage cup 16 thereupon positioned adjacent the mixing fixture 68. The beverage cup support 84 has a drain in fluid communication with the waste water reservoir 40. The dispenser 10 further includes a nozzle 72 in fluid communication with the mixing fixture 68. The finished beverage 18 is dispensed through the nozzle 72. The beverage cup support 84 is positioned directly below the nozzle 72. I this regard, it is contemplated that the any spillage of finished beverage 18 would drain through the beverage cup support 84 and to the waste water reservoir 40.

The dispenser 10 may further include a controller 50. The controller 50 is disposed in electrical communication with the pump 48, the ionizer 54 and the valve 60. The controller 50 is configured to control fluid flow through the mixing fixture 68 through cooperative controlling of the pump 48, the ionizer 54 and the valve 60 in terms of flow rate and amount of fluid dispensed to the mixing fixture 68. In this regard, the controller 50 may engage the pump 48 to flow alkaline water to the valve 50. This engagement would be cooperative with the actuation of the valve 50 to allow a selected amount of alkaline water to flow through the valve 50, such as a pre-determined amount of liquid defining a single serve amount. The valve 50 may be a solenoid device for example. The alkaline water reservoir 56 may be a variable volume bladder that is configured to hold and/or dispense a specific amount or preselected amounts of fluid so as to correspond to desired single serve amounts of fluid. The alkaline water reservoir 56 may be configured to receive alkaline water until the water pressure is equal to a maximum pump pressure from the pump 48. Upon such pressure being achieved, the valve 50 may be actuated to allow fluid flow to the mixing fixture 68. Though not depicted, it is contemplated that an additional pump may be provided and that the pump 48 may be located at other locations along the fluid conduit described above. In addition, the controller 50 is disposed in electrical communication with the temperature element 58. The temperature element 58 is disposed in fluid communication with the alkaline water from the alkaline water reservoir 56. The temperature element 58 may be configured to heat or cool the alkaline water. The temperature element 58 may include multiple components for heating and/or cooling. It is also contemplated that the temperature element 58 may be disposed downstream of the alkaline water reservoir 56.

The controller 50 may further have user controls such as an on/off switch 74, start/pause switch 76, a PH control 78, a temperature control 80, and a display 82. The on/off switch 74 is configured to sense input from the user to the controller 50 for electrical on/off control of the dispenser 10. The start/pause switch 76 is configured to sense input from the user to the controller 50 for controlling the temporary stoppage and starting of the dispensing of the finished beverage 18. This may be accomplished to electrical controlling of the pump 48 and/or the valve 60. The PH control 78 is configured to sense input from the user to the controller 50 for controlling the PH level of the alkaline water produced by the ionizer 54. The temperature control 80 is configured to sense input from the user to the controller 50 to control the temperature element 58 to allow for selected heating or cooling of the alkaline water in the alkaline water reservoir 56. In this regard the temperature element 58 may be thermostatically controlled. This ultimately is intended to control the fluid temperature of the finished beverage 18 as dispensed from the dispenser 10. The display 82 may be configured to provide information regarding the status of the particular beverage being made, such as water temperature, PH level, or amount dispensed (including historical usage information). In addition, the display may be used to output text or graphic information regarding the beverage being made, such as information about the ingredients or health benefits. It is contemplated that such information would be electronically stored in a computer memory as incorporated into the electronics of the controller 50. It is contemplated that the components, fabrication and electrical interconnection of the various electrical elements of the dispenser 10, including the controller 50, the pump 48, the ionizer 54, the valve 60, the temperature element 58, the on/off switch 74, the start/pause switch 76, the PH control 78, the temperature control 80, and the display 82, may be chosen from those which are well known to one of ordinary skill in the art.

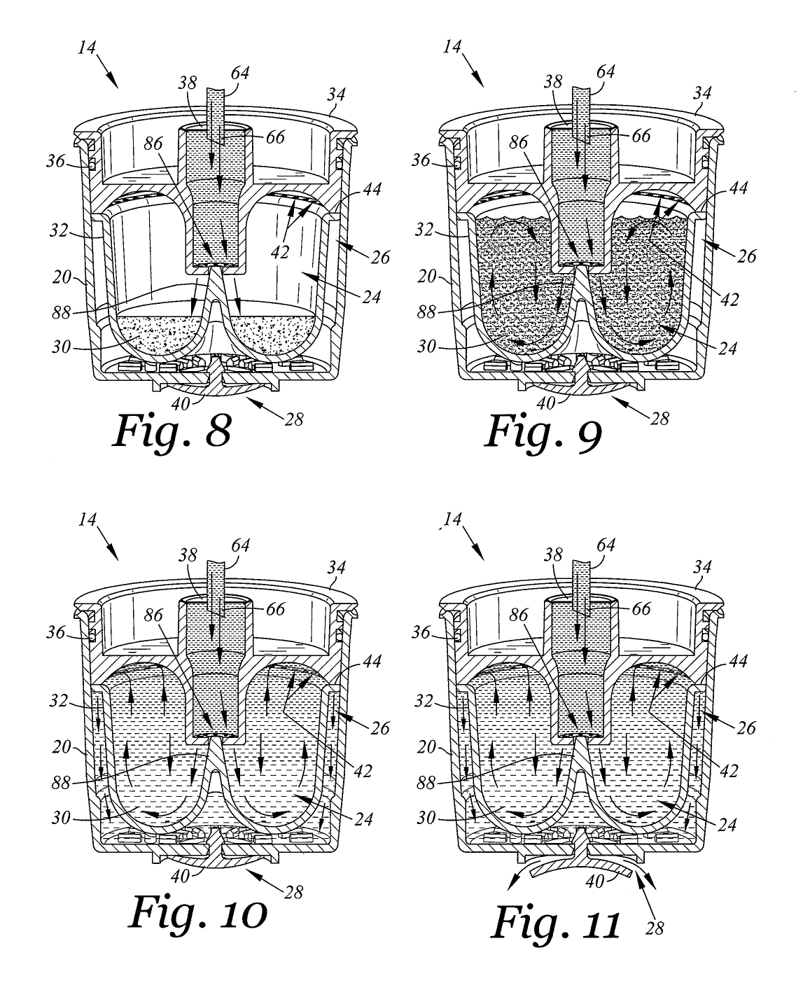

Referring now to FIGS. 8-11 there is sequentially depicted the assembled cross sectional side view of the single serve beverage capsule 14 of FIG. 4 as interacting with a fluid nozzle 64 of a single serve beverage dispenser 10. FIG. 8 depicts the fluid nozzle 64 being inserted through the inlet seal 38. In particular the inlet piercing element 66 is configured to readily poke through the inlet seal 38. The inlet piercing element 66 may include an angle end to form a cutting or piercing edge to effectuate such function. The inlet seal 38 may be formed of a variety of materials as may be selected from those well know to one of ordinary skill in the art, such as a plastic membrane, metal foil or even a lined paper product. It is contemplated that closure of the cap 62 results in the inlet piercing element 66 being pushed through the inlet seal 38 to expose the fluid nozzle 64 in fluid communication with the inlet 22. Alkaline water is depicted as having been dispensed through the fluid nozzle 64 into the inlet.

As depicted in FIG. 9, the fluid flow of the alkaline water is injected through the exit openings 86 into the mixing chamber 24. The fluid flow is directed and channeled by the surface of the vertex 88. As such the fluid flow is directed downward along the curved surface of the mixing chamber insert 32. This results in a mixing of the alkaline water with the beverage media 30 (as indicated by the differing cross-hatching). Following the curved generally half-toroidal shaped surface, the fluid flow is directed upward along the mixing chamber insert 32 towards the inlet insert 34. This configuration is contemplated to be particularly effective in producing turbulent mixing of fluid injected into the mixing chamber 24. As depicted in FIG. 10, the injected alkaline water and the beverage media 30 is mixed through a turbulent swirling action that is facilitated by the geometry of the mixing chamber 24.

As depicted in FIG. 10, the mixed alkaline water with the beverage media 30 follows the unfiltered fluid path through the plurality of openings 42 to enter into the outlet reservoir 26. At this stage, it is contemplated that the beverage media 30 is substantially dissolved into the injected alkaline water. As depicted in FIG. 10, the mixed alkaline water with the beverage media 30 follows the unfiltered fluid path through the outlet 28. This is accomplished by a sufficient pressure of the fluid flow upon the one-way valve 40. The one-way valve 40 is deformed to allow for passage of the fluid flow to produce a finished beverage 18 exiting the capsule 14 in response to such fluid pressure. As the capsule 14 is disposed in the mixing fixture 68, the finished beverage 18 exits the dispenser 10 through the nozzle 72. The beverage cup 16 may be positioned to receive the finished beverage 18.

According to yet another embodiment, there is provided a method of producing a single-serve beverage, such as the finished beverage 18. The method includes a step (a) of providing reservoir water in the water reservoir 46 of the single serve beverage dispenser 10. The method further includes a step (b) of separating the reservoir water into alkaline water and acidic water using the ionizer 54. The method further includes a step (c) of pumping the alkaline water to the mixing fixture 68 of the single serve beverage dispenser 10. The mixing fixture 68 sized and configured receive the single serve beverage capsule 14. The method further includes a step (d) of providing the single serve beverage capsule 14 within the mixing fixture 68. The capsule 14 includes the capsule housing 20, the inlet 22, the mixing chamber 24, the beverage media 30, and the outlet 28. The mixing chamber 24 is disposed in the capsule housing 20 in fluid communication with the inlet 22. The beverage media 30 is disposed within the mixing chamber 24. The outlet 28 is disposed in the fluid communication with the mixing chamber 24. The method further includes a step (e) of flowing the single serve amount of alkaline water into the inlet 22 of the capsule 14. The method further includes a step (f) of mixing the alkaline water with the beverage media 30 to produce the finished beverage 18. The method further includes a step (g) of dispensing the finished beverage 18 from the capsule 14 through the outlet 28. The finished beverage 18 may then be enjoyed by the user. In addition, the dispenser 10 may further include the waste water reservoir 70, and step (c) may further include flowing the acidic water to the waste water reservoir 70. The step (g) may include providing the beverage cup 16 positioned above the waste water reservoir 70 and receiving the finished beverage 18 in the beverage cup 16. Once the finished beverage 18 is dispensed, the user may open the cap 62 and remove the now used capsule 14 (less the beverage media 30). The dispenser 10 is then ready to receive another single serve beverage capsule 14 for producing another single serve finished beverage 18.

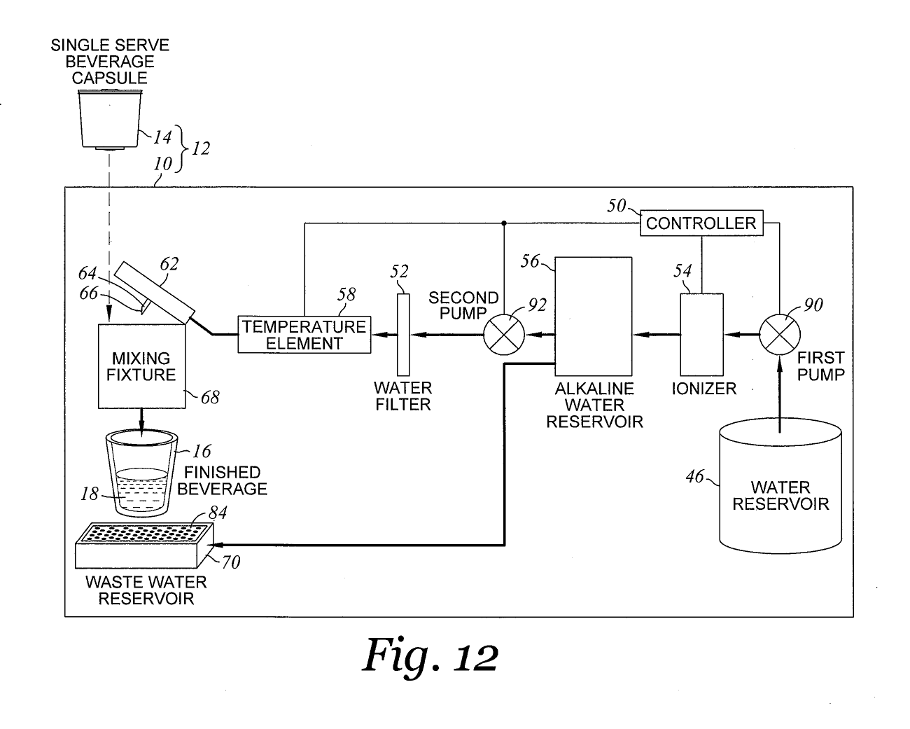

Referring now to FIG. 12 there is depicted a symbolic diagram of a single serve beverage system 12, according to another embodiment, including the single serve beverage dispenser 10 and the capsule 10. Similar reference numerals as those in relation to the embodiment shown in FIGS. 1-11 are used to indicate similarly configured components, however, with those differences as noted below. In this embodiment there is provided a first pump 90 in fluid communication with the water reservoir 46. The first pump 90 is controlled and in electrical communication with the controller 50. The first pump 90 is used to pump reservoir water to the ionizer 54. The ionizer 54 is configured to produce alkaline water. A second pump 92 is provided downstream of the ionizer 54 for pumping the alkaline water. The second pump 92 is configured to have an output pump pressure higher than the first pump 90. In this regard, the first pump 90 needs only a pump pressure sufficient to provide the intake feed water for usage by the ionizer (i.e., a relatively low pressure requirement). The alkaline water reservoir 56 is in fluid communication with the ionizer 54 for receiving alkaline water. The alkaline water is pumped from the alkaline water reservoir 56 using the second pump 92. The water filter 52 and the temperature element 58 may be optionally provided downstream of the second pump 92. The second pump 92 is configured to pump the alkaline water to the mixing fixture 68. The mixing fixture 68 is used to mix the beverage media 30 (as described above). In this embodiment, it is contemplated that the beverage media 30 may be provided with or without the use of a capsule 14. The controller 50 is configured to control the second pump 92. In this regard, the controller 50 may be used to actuate the second pump 92 to pump a single service amount of alkaline water for dispensing through the mixing fixture 68. As such, this embodiment does not need any controlled valve to regulate the flow of liquid. In yet another embodiment, it is contemplated that the ionizer 54 is optional and only the second pump 92 may be used to pump reservoir water from the water reservoir 46 to the mixing fixture 68.

The particulars shown herein are by way of example and for purposes of illustrative discussion of the embodiments of the present invention only and are presented in the cause of providing what is believed to be the most useful and readily understood description of the principles and conceptual aspects. In this regard, no attempt is made to show more details than is necessary for a fundamental understanding of the disclosure, the description taken with the drawings making apparent to those skilled in the art how the several forms of the presently disclosed invention may be embodied in practice.

What is claimed is:

1. A single serve beverage capsule comprising:
a capsule housing;
an inlet;
a mixing chamber disposed in the capsule housing in fluid communication with the inlet;
an outlet reservoir disposed in the capsule housing in fluid communication with the mixing chamber;
an outlet disposed in the fluid communication with the outlet reservoir; and
beverage media disposed within the outlet reservoir, the beverage media being substantially dissolvable in an aqueous based liquid; and
wherein the inlet, the mixing chamber, outlet reservoir, and the outlet sequentially defining an unfiltered fluid path with respect to the dissolvable beverage media after having been immersed in an ambient temperature fluid.

2. The capsule of claim 1 wherein the inlet is centered within the mixing chamber.

3. The capsule of claim 1 wherein the inlet is disposed opposite the outlet.

4. The capsule of claim 1 further includes a membrane disposed across the inlet.

5. The capsule of claim 1 wherein the mixing chamber includes a generally half-toroidal shaped portion.

6. The capsule of claim 1 wherein the mixing chamber is generally toroidal shaped.

7. The capsule of claim 1 wherein the outlet includes a one-way valve sized and configured to allow fluidic flow from the outlet reservoir to beyond the capsule housing.

8. The capsule of claim 7 wherein the one-way valve is a mushroom valve.

9. The capsule of claim 1 wherein the outlet reservoir is disposed circumferentially about the mixing chamber.

10. The capsule of claim 1 further includes a plurality of openings disposed between the mixing chamber and the outlet reservoir, the unfiltered fluid path extends through the plurality of openings.

11. The capsule of claim 10 wherein the plurality of openings are disposed circumferentially about the mixing chamber.

12. The capsule of claim 1 further includes a mixing chamber insert, the mixing chamber is defined by and disposed within the mixing chamber insert, the outlet reservoir is disposed between the mixing chamber insert and the capsule housing.

13. The capsule of claim 12 further includes a plurality of openings formed in the mixing chamber insert, the unfiltered fluid path extends through the plurality of openings.

14. The capsule of claim 13 wherein the plurality of openings is disposed circumferentially about the mixing chamber.

15. The capsule of claim 1 wherein the beverage media is substantially dissolvable in an aqueous based liquid at ambient temperature.

16. A single serve beverage capsule for use with a single serve amount of liquid, the capsule comprising:
a capsule housing;
an inlet;
a mixing chamber disposed in the capsule housing in fluid communication with the inlet, the mixing chamber being sized and configured to create wave-like mixing of a single serve amount of liquid from the inlet;
an outlet reservoir disposed in the capsule housing in fluid communication with the mixing chamber;
an outlet disposed in the fluid communication with the outlet reservoir; and
beverage media disposed within the outlet reservoir.

17. The capsule of claim 16 wherein the beverage media is substantially dissolvable in a single serve amount of liquid flowing through the mixing chamber.

18. The capsule of claim 16 wherein the mixing chamber includes a generally half-toroidal shaped portion.

19. The capsule of claim 16 wherein the beverage media is substantially dissolvable in an aqueous based liquid.

20. The capsule of claim 19 wherein the beverage media is substantially dissolvable in an aqueous based liquid at ambient temperature.

21. The capsule of claim 16 wherein the inlet, the mixing chamber, outlet reservoir, and the outlet sequentially define an unfiltered fluid path with respect to the beverage media after having been immersed in an ambient temperature fluid.

22. A single service beverage system comprising:
a single serve beverage capsule including:
a capsule housing;
an inlet;
a mixing chamber disposed in the capsule housing in fluid communication with the inlet;
an outlet reservoir disposed in the capsule housing in fluid communication with the mixing chamber;
an outlet disposed in the fluid communication with the outlet reservoir; and
beverage media disposed within the outlet reservoir, the beverage media being substantially dissolvable in an aqueous based liquid; and
wherein the inlet, the mixing chamber, outlet reservoir, and the outlet sequentially defining an unfiltered fluid path with respect to the dissolvable beverage media after having been immersed in an ambient temperature fluid; and
a beverage dispenser including:
a water reservoir sized and configured to retain reservoir water;
a mixing fixture sized and configured to receive the single serve beverage capsule;
an inlet piercing element in fluid communication with the single serve beverage capsule; and
a pump in fluid communication with the inlet piercing element and the water reservoir, the pump being sized and configured to pump reservoir water from the water reservoir to the inlet piercing element through the capsule and out the outlet.

23. The single service beverage system of claim 22 wherein the beverage dispenser further includes a valve in fluid communication with the pump and the inlet piercing element, the valve being sized and configured to release a single serve amount of reservoir water from the pump and through the single service beverage capsule.

24. A single service beverage system comprising:
a single serve beverage capsule including:
a capsule housing;
an inlet;
a mixing chamber disposed in the capsule housing in fluid communication with the inlet, the mixing chamber being sized and configured to create wave-like mixing of a single serve amount of liquid from the inlet;
an outlet reservoir disposed in the capsule housing in fluid communication with the mixing chamber;
an outlet disposed in the fluid communication with the outlet reservoir; and
beverage media disposed within the outlet reservoir; and
a beverage dispenser including:
a water reservoir sized and configured to retain reservoir water;
a mixing fixture sized and configured to receive the single serve beverage capsule;
an inlet piercing element in fluid communication with the single serve beverage capsule; and
a pump in fluid communication with the inlet piercing element and the water reservoir, the pump being sized and configured to pump reservoir water from the water reservoir to the inlet piercing element through the capsule and out the outlet.

25. The single service beverage system of claim 24 wherein the beverage dispenser further includes a valve in fluid communication with the pump and the inlet piercing element, the valve being sized and configured to release a single serve amount of reservoir water from the pump and through the single service beverage capsule.
